(19) United States
(12) Patent Application Publication
(10) Pub. No.: US 2019/0250811 A1
(43) Pub. Date: Aug. 15, 2019

(54) Input Accepting Device

(71) Applicant: Kyocera Document Solutions Inc., Osaka (JP)

(72) Inventor: Koichi Tanaka, Osaka (JP)

(73) Assignee: Kyocera Document Solutions Inc.

(21) Appl. No.: 16/270,579

(22) Filed: Feb. 7, 2019

(30) Foreign Application Priority Data
Feb. 9, 2018 (JP) 2018-022061

(51) Int. Cl. G06F 3/0488; G06F 3/0482

(52) U.S. Cl. CPC G06F 3/04883; G06F 3/0482

(57) ABSTRACT

An input accepting device includes a touch panel display, an input signal processing unit, and a control unit. The control unit recognizes an input corresponding to an operation key in accordance with a positional relationship between a recognized contact portion and the operation key in the on-screen keyboard. When the contact portion is recognized to correspond to the two or more operation keys, the control unit redisplays a new on-screen keyboard on the touch panel display in a state where the positional relationship of the respective operation keys in the arrangement on the on-screen keyboard is maintained, the new on-screen keyboard displaying the two or more operation keys in a style different from the other operation keys, and the control unit recognizes an operation with respect to the on-screen keyboard with the input signal processing unit.

### INCORPORATION BY REFERENCE

This application is based upon, and claims the benefit of priority from, corresponding Japanese Patent Application No. 2018-022061 filed in the Japan Patent Office on Feb. 9, 2018, the entire contents of which are incorporated herein by reference.

### BACKGROUND

Unless otherwise indicated herein, the description in this section is not prior art to the claims in this application and is not admitted to be prior art by inclusion in this section.

For various kinds of inputs (such as character inputs) in a personal computer or similar device, a keyboard with a plurality of operation keys arranged thereon is used, and a display, which displays various kinds of information and outputs, is located separately from the keyboard. On the other hand, in various kinds of small-sized mobile devices such as a mobile phone and a smart phone, a touch panel display that can be used as a display and can also be used for performing various kinds of inputs is used because of difficulty in locating a keyboard and a display separately. In this case, a virtual keyboard (an on-screen keyboard) is displayed in one region of the touch panel display, and a user, by touching respective operation keys on the on-screen keyboard, can perform operations substantially similar to a keyboard in the above-described personal computer. In view of this, on a surface of a touch panel display, a function that can recognize a portion (a region) touched by a user's finger is provided.

However, operating such a small on-screen keyboard causes high probability of improper operations because the respective operation keys constituting it are small and the operation keys are densely arranged. In many cases, the plurality of adjacent operation keys are simultaneously touched. When the plurality of operation keys are simultaneously touched as described above, there is proposed a technique that overlaps only the simultaneously touched plurality of operation keys with the original on-screen keyboard and newly displays them in a large size. By operating the large-sized operation keys again, which are newly displayed, by the user, the user can recognize the operation keys again that the user should have operated originally and can perform the operation again. This ensures causing the user to perform appropriate operations even when a small on-screen keyboard is used.

### SUMMARY

An input accepting device according to one aspect of the disclosure includes a touch panel display, an input signal processing unit, and a control unit. The touch panel display displays an on-screen keyboard with a plurality of operation keys arranged thereon. The input signal processing unit recognizes a contact portion touched by a user in the touch panel display. The control unit recognizes an input corresponding to the operation key in accordance with a positional relationship between the recognized contact portion and the operation key in the on-screen keyboard. When the contact portion is recognized to correspond to the two or more operation keys, the control unit redisplays a new on-screen keyboard on the touch panel display in a state where the positional relationship of the respective operation keys in the arrangement on the on-screen keyboard is maintained, the new on-screen keyboard displaying the two or more operation keys in a style different from the other operation keys, and the control unit recognizes an operation with respect to the on-screen keyboard with the input signal processing unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram illustrating a configuration related to control of an input accepting device according to one embodiment of the disclosure;

FIG. 2 illustrates a configuration of an on-screen keyboard in the input accepting device according to the one embodiment;

FIGS. 3A to 3C illustrate a first example of behaviors relative to the on-screen keyboard in the input accepting device according to the one embodiment;

FIGS. 4A to 4D illustrate a second example of the behaviors relative to the on-screen keyboard in the input accepting device according to the one embodiment;

FIGS. 5A and 5B illustrate a third example of the behaviors relative to the on-screen keyboard in the input accepting device according to the one embodiment;

FIG. 6 illustrates one example of the behaviors in the input accepting device according to the one embodiment;

FIGS. 7A and 7B illustrate other behaviors in the input accepting device according to the one embodiment; and

FIG. 8 illustrates a flowchart corresponding to the other behaviors in the input accepting device according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

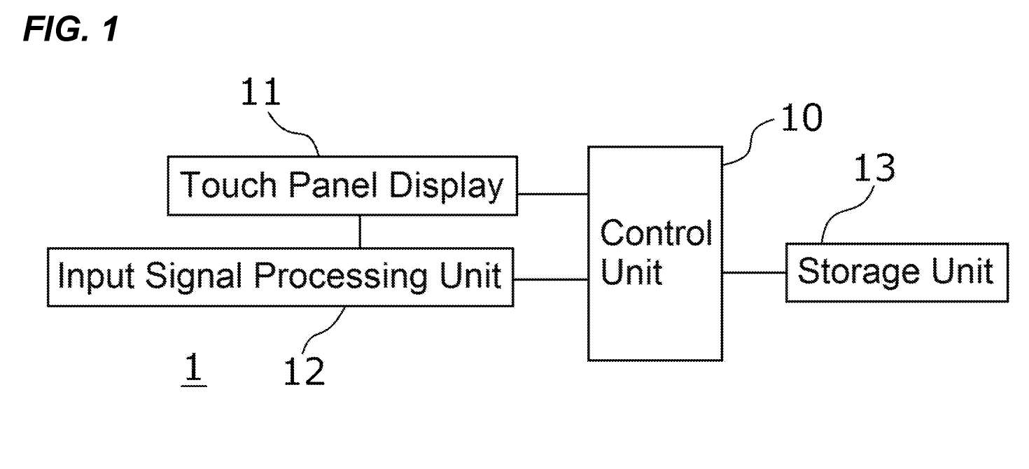

The following describes a configuration for implementing the disclosure with reference to the accompanying drawings. An input accepting device as an embodiment is a small-sized portable terminal 1, and FIG. 1 illustrates a block diagram illustrating its configuration. Here, descriptions for components irrelevant to the disclosure are omitted. As illustrated in FIG. 1, the portable terminal 1 includes a touch panel display 11 for input and output. The touch panel display 11 is similar to one constituted by a resistance film method or a capacitive type method, which is conventionally known, can cause to display various kinds of information and two-dimensional images, and when a user's finger touches its surface, can electrically recognize its contact portion by an input signal processing unit 12. In view of this, after causing the touch panel display 11 to display an image (an on-screen keyboard) corresponding to an arrangement of the operation keys, touching a portion corresponding to the respective operation keys by a user's finger can cause to recognize that the operation key displayed at the portion is operated. Thus, this arrangement can be dealt with similarly to a keyboard in an ordinary personal computer.

A control unit 10 including a CPU, based on an operation instruction input by the touch panel display 11 (the on-screen keyboard) as described above and an operation instruction via a network, performs behaviors of the portable terminal 1. The touch panel display 11 is used also to display the outputs in this case. When performing such behaviors, the control unit 10 can use various kinds of data stored temporarily or permanently in a storage unit 13.

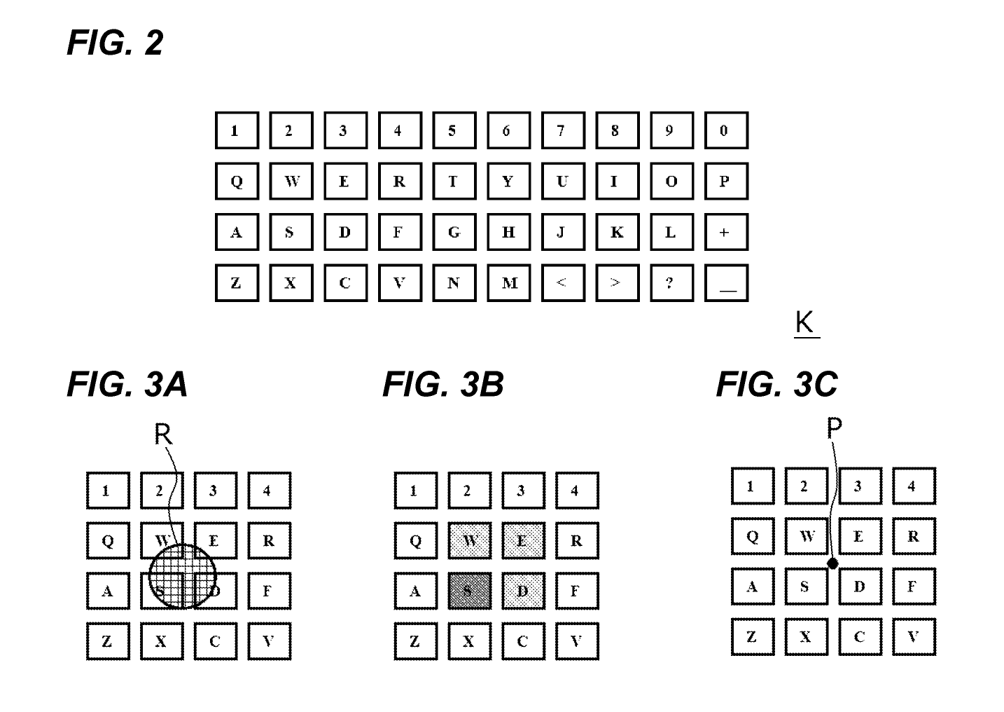

FIG. 2 illustrates a configuration of an on-screen keyboard K displayed on the touch panel display 11 in this case. The on-screen keyboard K is set to be a Roman character inputting method; in practice, while other operation keys (such as an Enter key and a Shift key) are also located in a peripheral area, the illustrations are omitted.

In operating the on-screen keyboard K illustrated in FIG. 2 by a user (touching any of the operation keys in the on-screen keyboard K by a user's finger) in the touch panel display 11, when the touch panel display 11 is constituted by, for example, the capacitive type method, as a contact portion, the input signal processing unit 12 can recognize a region (a contact region) of an area of a certain region on the touch panel display 11 touched by the finger. When this region is within a region displayed as a single operation key in FIG. 2, the control unit 10 can recognize that this operation key has been operated. However, when the touch panel display 11 is small, and the on-screen keyboard K is small, the respective operation keys are small and intervals between the adjacent operation keys are narrow. Thus, the contact region can extend over the plurality of adjacent operation keys.

When the touch panel display 11 is constituted by, for example, the resistance film method, the input signal processing unit 12 can recognize one point on the touch panel display 11 as a representative point as the contact portion touched by the finger. When the one point is within a region displayed as the single operation key in FIG. 2, the control unit 10 can recognize that this operation key has been operated. However, the contact portion can reside not in the region displayed as the single operation key but between the adjacent operation keys.

That is, in both cases where the contact portion is recognized as a region and is recognized as a point, as described above, while it is recognized that a user has performed some operation (a user's finger has touched the touch panel display 11), there is a case where which operation key is operated is unclear. The portable terminal 1 features the behaviors in this case. The following describes this point.

First, FIG. 3A illustrates a case where the region (a contact region R) that is recognized as being touched by the user's finger as described above extends over the plurality of operation keys. Here, only a related portion in the on-screen keyboard K is illustrated, and the contact region R includes a portion overlapping with a “W” key, an “E” key, an “S” key, and a “D” key that are adjacent to one another. In view of this, the control unit 10, in this case, does not accept the input by this operation and suspends it at this stage.

The input signal processing unit 12 and the control unit 10 can recognize such contact region R on a coordinate of the touch panel display 11, and the control unit 10 can recognize the region occupied by the respective operation keys described above on the coordinate of the touch panel display 11. Thus, the control unit 10 can recognize an area where the region occupied by each of the respective operation keys described above overlaps with the contact region R. In the example in FIG. 3A, this area is the largest in the “S” key.

In view of this, the control unit 10 rewrites only a portion corresponding to FIG. 3A in the on-screen keyboard K in FIG. 2 as illustrated in FIG. 3B and displays with the touch panel display 11 without changing other portions. Here, the “W” key, the “E” key, the “S” key, and the “D” key, which are the operation keys where the overlaps with the contact region R have been recognized, are highlighted (hatched) as a candidate; of these, the “S” key, which has the largest overlapping area, is especially emphasized and displayed as a first candidate. In FIG. 3B, while the “W” key, the “E” key, and the “D” key are equally hatched, the display may be changed in accordance with the respective overlapping areas. In this case, since the overlapping areas are large in order of the “S” key, the “D” key, the “W” key, and the “E” key, it is only necessary to perform dark hatching in this order.

Subsequently, when the on-screen keyboard K is displayed with such hatching performed on the operation keys, the user can perform the previous operation again to operate the desired operation key again. Then, when correspondence between the contact region R by this operation and the single operation key is established, the control unit 10 can proceed with the subsequent processes on the assumption that the previous suspended operation is caused by this operation key.

In this case, with recognizing by the display in FIG. 3B that the four operation keys described above have been simultaneously operated at the previous operation, the user can perform the reoperation. Furthermore, of these, clearly specifying the operation key as the first candidate ensures performing facilitated reoperation. In this case, in the on-screen keyboard K, the display of only the four operation keys related to the above-described behaviors is changed, and the other portions are not changed at all; and thus, this ensures performing the operation by a user without generating a significant change in a screen display.

In practice, when performing the above-described operation, the user performs a behavior of touching the on-screen keyboard K (the touch panel display 11) by his or her finger by a certain period of time. In view of this, the input signal processing unit 12 and the control unit 10 can recognize the contact region R described above immediately after the finger touches the touch panel display 11. After that, when a redisplay in FIG. 3B is performed, in many cases the user's finger still touches the touch panel display 11. In this case, the user can recognize inappropriateness because the plurality of operation keys are operated by his or her current operation, by the above-described display. After that, slightly moving the finger enables performing the appropriate operation. In view of this, when an ordinary user operates the operation key, the redisplay as described above is preferably performed in a period of time shorter than a period of time of touching the operation key (for example, within one second). However, even when the above-described redisplay is performed after the user releases his or her finger, it is possible to cause to perform the similar behaviors by the user touching the operation key again.

In the above-described example, determining whether to cause to perform such redisplay or not may be set in accordance with the overlapping area. For example, when it is recognized that the overlapping area in one operation key is sufficiently larger (for example, being equal to or more than five times) than the overlapping area in the other operation keys, the control unit 10, even when the overlaps between the contact region R and the plurality of operation keys are recognized, may proceed with the processes on the assumption that the operation key with the large overlapping area has been operated, without performing the redisplay as described above.

The above-described example describes a case where the operation by the user is recognized by the region with the certain area (the contact region R). Meanwhile, when the contact portion is recognized as a point (a contact point P) by the operation by the user, FIG. 3C illustrates a case where the contact point P is recognized as residing between the adjacent operation keys, similarly to FIG. 3A. In this case, while the control unit 10 can recognize that any of the operation keys near the contact point P has been operated by this operation, it cannot identify at the present stage which operation key has been operated. In view of this, it is possible to recognize that this situation is also similar to the above-described situation.

In this case, the control unit 10 can recognize a distance between the contact point P and the respective operation keys (a shortest distance) similarly as described above. Of these, the control unit 10 displays the operation key where the distance is small as the candidate similarly to FIG. 3B and can cause to display the operation key with the smallest distance among them as the first candidate. Here, the operation key to be selected as the candidate can be an operation key where the distance is smaller than the sizes (for example, one side of the rectangular shape in the configuration in FIG. 2) of the respective operation keys. Using the distance instead of the overlapping area in the above-described example enables performing the similar control described above.

Even when the contact portion can be recognized only as a point as described above, the determination similar to the above can be also performed, for example, by setting a circle with a radius r centering on this point (the contact point P) as the contact region R described above. In this case, the radius r can be appropriately set in accordance with a size of a user's finger or similar size.

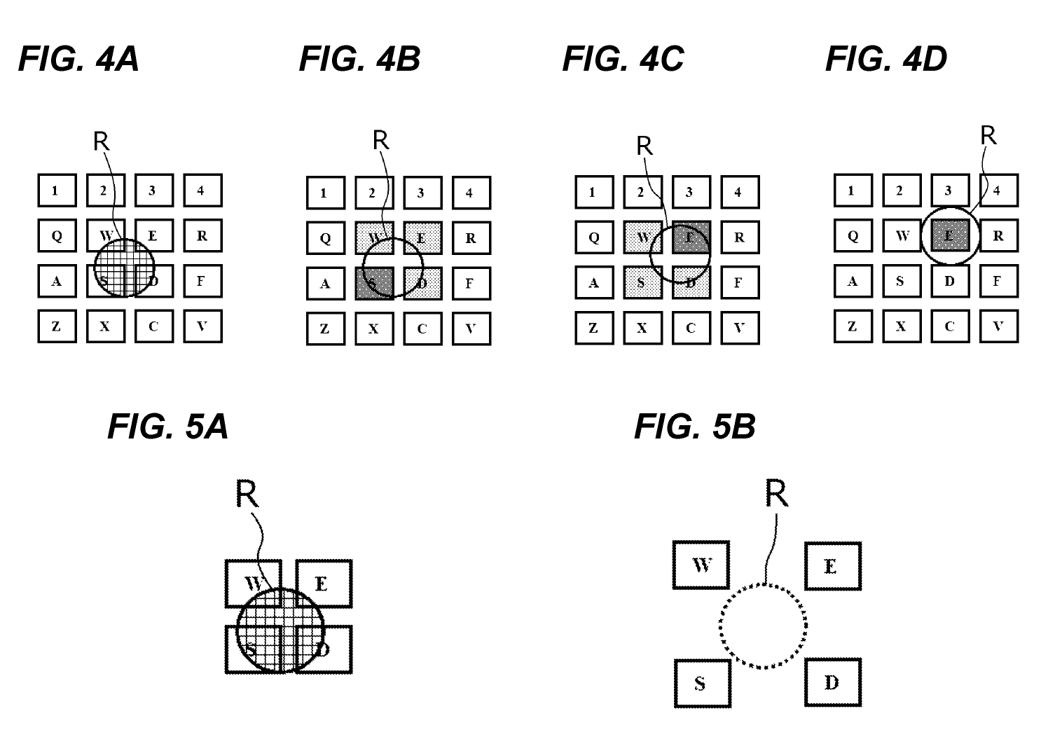

In performing the redisplay as described above, during a state where the user's finger is in contact with the touch panel display 11 is maintained, the process of recognizing the contact region R as described above and performing the redisplay in accordance with this recognition may be repeated in a short time. The following describes the behaviors in such a case. FIGS. 4A to 4D make the behaviors in such a case correspondent to FIGS. 3A to 3C to illustrate them.

FIGS. 4A and 4B illustrate the states that are identical to FIGS. 3A and 3B: namely, in the case of the on-screen keyboard K being displayed, a state where the contact region R overlapping with the four operation keys by the operation of the user is recognized; and a state where the redisplay is performed based on this recognition, respectively. Here, while the “S” key has been recognized as the first candidate, the case where the “E” key has been what the user actually has desired is illustrated. In view of this, the user can move his or her finger toward the “E” key without releasing his or her finger from the screen, and in this case, as illustrated in FIG. 4C, the redisplay is performed such that the overlapping area in the “E” key is gradually enlarged. In some cases, the operation keys to be the candidate are reduced, or changed.

Subsequently, as illustrated in FIG. 4D, the overlap is recognized between the contact region R and only the “E” key. Here, setting that the input signal processing unit 12 and the control unit 10 recognize that there has been the input by the operation key (the “E” key) recognized as being operated at a time when the user releases his or her finger from the touch panel display 11 performs the input of the “E” key at this time. The behavior of the finger as described above is known as a drag. In this case, the user can recognize what the control unit 10 side recognizes which operation key is currently operated, by the display described above.

That is, the user can especially easily operate the portable terminal 1 by setting as follows: the contact region R is recognized at a time when the user's finger touches the on-screen keyboard K; subsequently, the recognition of the contact region R and the associated redisplay are repeated within a short time; and then when the finger is released from the on-screen keyboard K (touch panel display) in a state where finally only a single operation key is recognized as having being operated, the input of this operation key is performed.

In the example described above, while the operation key with the largest overlapping area is redisplayed as the first candidate (the high priority level operation key), the first candidate (the priority level) can be set from other aspects. For example, a high usage frequency operation key (such as an Enter key, a punctuation key, or a vowel operation key) may be displayed as the first candidate. The priority level can be also set in accordance with a current display content. For example, when currently, in the touch panel display 11, a screen for setting of a certain parameter is displayed, an operation key (various kinds of direction keys) used for an increasing/decreasing operation of a value of the parameter is preferably set as the first candidate. In this case, in setting the determination whether to cause to perform the redisplay or not as described above in accordance with the overlapping area, the determination criteria may be changed in accordance with the priority level. For example, for the high priority level operation key, recognizing the input without performing the redisplay even with a less overlapping area enables more efficient operation.

Even when the user once releases his or her finger from the touch panel display 11 before the redisplay without performing a drag, it is possible to perform the appropriate operation as described above after the redisplay similarly to the above. On the other hand, without assuming dragging as described above, when assuming that the user once releases his or her finger from the touch panel display 11 before the redisplay, it is possible to perform a redisplay different from the case described above.

FIGS. 5A and 5B illustrate an example of the redisplay assuming that the finger is released at a time of the redisplay as described above. FIG. 5A, similarly to FIG. 3A, illustrates a relationship between the four operation keys (the “W” key, the “E” key, the “S” key, and the “D” key) and the contact region R in the on-screen keyboard K at a time of the first operation. Here, in practice, the size of the contact region R often depends on, for example, the size of the user's finger. In view of this, the state in FIG. 5A can be thought that the display of such on-screen keyboard K is inappropriate for this user. In view of this, when the states in FIGS. 5A and 5B are recognized, as illustrated in FIG. 5B, the control unit 10 can redisplay the intervals between the operation keys (the “W” key, the “E” key, the “S” key, and the “D” key), which are to be the candidate, after widening them. In this case, the control unit 10 can set the intervals between these operation keys considering the size of the recognized contact region R. That is, setting the size of the contact region R so as to be proportionate to the intervals ensures performing the operation after the redisplay.

In this case, it is possible to cause to arrange the operation keys other than the operation keys displayed in FIG. 5B outside the display in FIG. 5B with an original layout maintained. In this case, the newly displayed on-screen keyboard K becomes larger. However, by displaying the operation keys other than the operation keys displayed in FIG. 5B smaller than their original sizes, the whole size of the on-screen keyboard K may be maintained. As described above, here, since only the intervals of a part of the operation keys, which are to be the candidate, are widen, even in such a case, the sizes of the operation keys that are displayed small are not significantly changed from their original sizes.

In the cases in FIGS. 3A to 3C and FIGS. 4A to 4D where it is assumed that the user's finger does not move during a period from a time of the original display to a time of the redisplay to touch the touch panel display 11, positions of the four operation keys (or all the operation keys) as the candidate are not changed between the time of the original display and the time of the redisplay. In contrast to this, in the behaviors in FIGS. 5A and 5B, the positions of the four operation keys (or all the operation keys) as the candidate are moved at the time of the redisplay from positions of the time of the original display. In this case, when the finger touches the touch panel display 11 again at the original position, or the finger touches the touch panel display 11 without moving during a period from the time of the original display to the time of the redisplay, there is possibility that the finger is touching an unexpected operation key at the time of the redisplay. Thus, in performing the redisplay in FIG. 5B, the contact region R at a time of recognition is preferably set to reside in a region (a position where the contact region R does not overlap with any operation keys) between the operation keys.

However, in this case, in accordance with the shape of the contact region R, the interval in a longitudinal direction and the interval in a lateral direction may be changed. In addition to just the size of contact region R, the control unit 10 can store data (such as correlation between the targeted operation keys and the size and shape of the contact region R) in having performed the redisplay in the past as described above in the storage unit 13 and appropriately perform this setting based on the date.

When performing the behaviors in FIGS. 5A and 5B, the interval newly set in FIG. 5B can be automatically set by the control unit 10 as described above. However, the user sometimes does not desire this interval. In view of this, in performing the redisplay in FIG. 5B, it is especially preferable to cause to display a key for confirming whether the redisplay is acceptable or not, near the on-screen keyboard K or overlapped with the part of it. In this case, when the key for confirmation is operated (an answer that the redisplay is acceptable is obtained), the reoperation relative to the redisplay is set to be effective. When this redisplay is not desired, the control unit 10 can cause to perform the redisplay with a changed interval. This ensures more reliable and easier operation for a user.

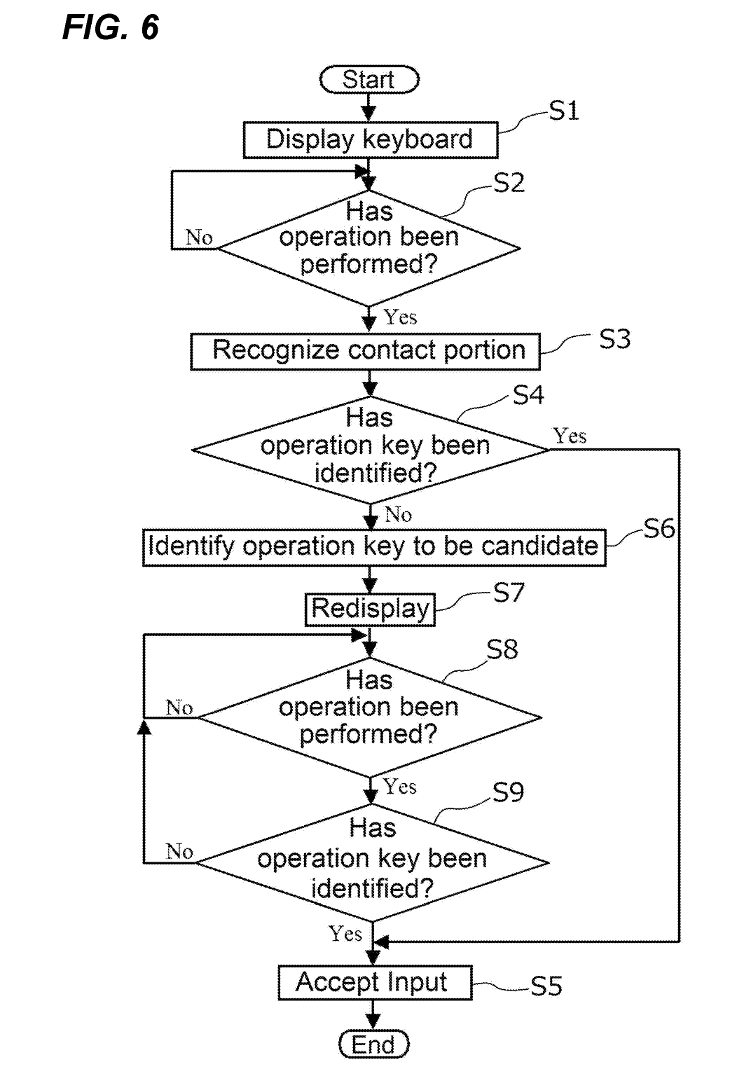

FIG. 6 illustrates one example of the behaviors of the control unit 10 as described above. Here, a flow chart from displaying the on-screen keyboard K (Step S1) up to accepting the input by this by the control unit 10 is illustrated. First, the control unit 10 recognizes whether any operation has been performed with respect to the touch panel display 11 (whether the user touches the touch panel display 11) by the input signal processing unit 12 (Step S2). When the operation has been performed (Yes at Step S2), the control unit 10 recognizes the contact portion by the input signal processing unit 12 as described above (Step S3) and recognizes which operation key is operated based on the positional relationship between the contact portion and the operation key. When the correspondence between the contact portion and the single operation key is established (Yes at Step S4) as described above, the control unit 10 accepts the input corresponding to this operation key (Step S5). In practice, as described above, the input is accepted at a time when the user's finger is released from the touch panel display 11.

When the correspondence between the contact portion and the single operation key cannot be established as described above (No at Step S4), namely, the state of FIG. 3A or 3C is recognized, the control unit 10 identifies a plurality of operation keys to be a candidate as described above (Step S6). In this case, the priority level may be set as described above. The control unit 10 performs the redisplay (see FIGS. 3B and 5B) that displays the plurality of operation keys, which have become the candidates, in a style different from the original on-screen keyboard K (Step S1) as in FIGS. 3B and 5B (Step S7). In this case, for the user to recognize that the current display is the redisplay as described above, generating an alert sound may be set. A click sound in the operation after the redisplay may be changed from the click sound in the ordinary operation. Alternatively, a “?” mark may be displayed by overlapping with or beside the operation key as the candidate. Subsequently, the control unit 10 recognizes whether the operation has been performed or not after the redisplay (Step S8) similarly as described above (Step S2) and when the operation has been performed (Yes at Step S8), similarly as described above (Step S4), recognizes which operation key has been operated (Step S9). Here, when the control unit 10 could not identify the operation key (No at Step S9), it may wait a new operation after prompting the new operation or may wait the additional operation with no reaction (Step S8).

When the operation key can be identified at the reoperation after the redisplay (Yes at Step S9), the input corresponding to this operation key is accepted (Step S5). When there are many operation keys as the candidates (Step S6), and the operation key cannot be identified (No at Step S9) even after the redisplay (Step S7), similarly to the previous steps (Steps S6 and S7), the reoperation may be performed after newly narrowing down the candidate from these and performing the new redisplay.

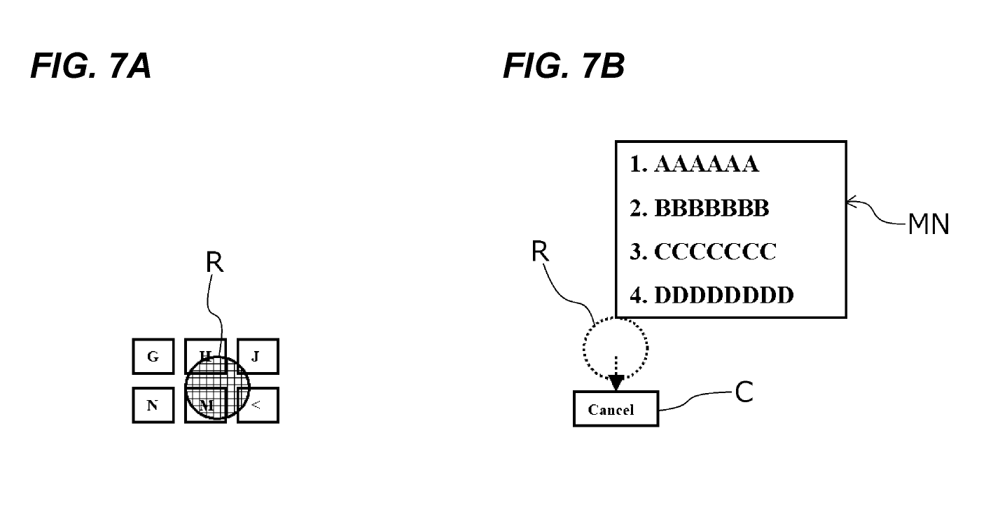

In some cases, an especial, specific function is allocated with respect to one of the operation keys recognized as the candidate as described above; for example, there is a case of a setting as operating one of these operation keys shifts to a next operation screen (a screen for setting an operation or a parameter by, for example, a menu). FIGS. 7A and 7B illustrate an example when the redisplay is performed in a case where the operation by the one operation key is an operation for displaying a specific image (a specific image) as described above. In FIG. 7A, in the on-screen keyboard K in FIG. 2, the “M” key corresponds to a menu; operating the “M” key (a specific operation key) is set so as to switch to a menu screen (the specific image). Here, as illustrated in FIG. 7A, assume that the contact region R is recognized such that the “M” key is set to be the first candidate of these. Further, assume that the user's finger is held on the touch panel display 11 with the contact region R in FIG. 7A maintained.

In this case, the control unit 10, although the operation of the “M” key is not confirmed, on the assumption that the “M” key is operated, deletes the on-screen keyboard K and temporarily displays a menu screen MN instead on the touch panel display 11, as illustrated in FIG. 7B. However, here, a Cancel (Cancel) key C that is an operation key for aborting the temporary display and displaying the original on-screen keyboard K again outside the menu screen MN is displayed. When the input signal processing unit 12 recognizes that the user has operated the Cancel key C, the control unit 10 deletes the menu screen MN and displays the original on-screen keyboard K again on the touch panel display 11.

Here, in FIG. 7B, the Cancel key C is displayed at a position where, while being close to the contact region R in FIG. 7A, the Cancel key C does not overlap with the contact region R. Assume that the input of the Cancel key C is confirmed at a time when the user's finger is released after touching it. In contrast, when the user's finger is released without touching the Cancel key C, it is recognized that the Cancel key C is not input, and the user accepts the appropriateness of displaying of the menu screen MN.

Thus, in a state in FIG. 7B where the menu screen MN is temporarily displayed, when the user directly releases his or her finger from the touch panel display 11 without dragging, only the Cancel key C is deleted in the state in FIG. 7B, and the operation with respect to the menu screen MN becomes effective. On the other hand, when the user does not desire the display of the menu screen MN, releasing his or her finger after dragging up to the position of the Cancel key C on the lower side in FIG. 7B causes the control unit 10 to recognize that the operation of the Cancel key C has been performed and displays the on-screen keyboard K again as described above.

With the operation described above, even when the operated operation key is not confirmed, performing the temporary display as described above ensures the reduced improper operations by a user and reduced fatigue of a user.

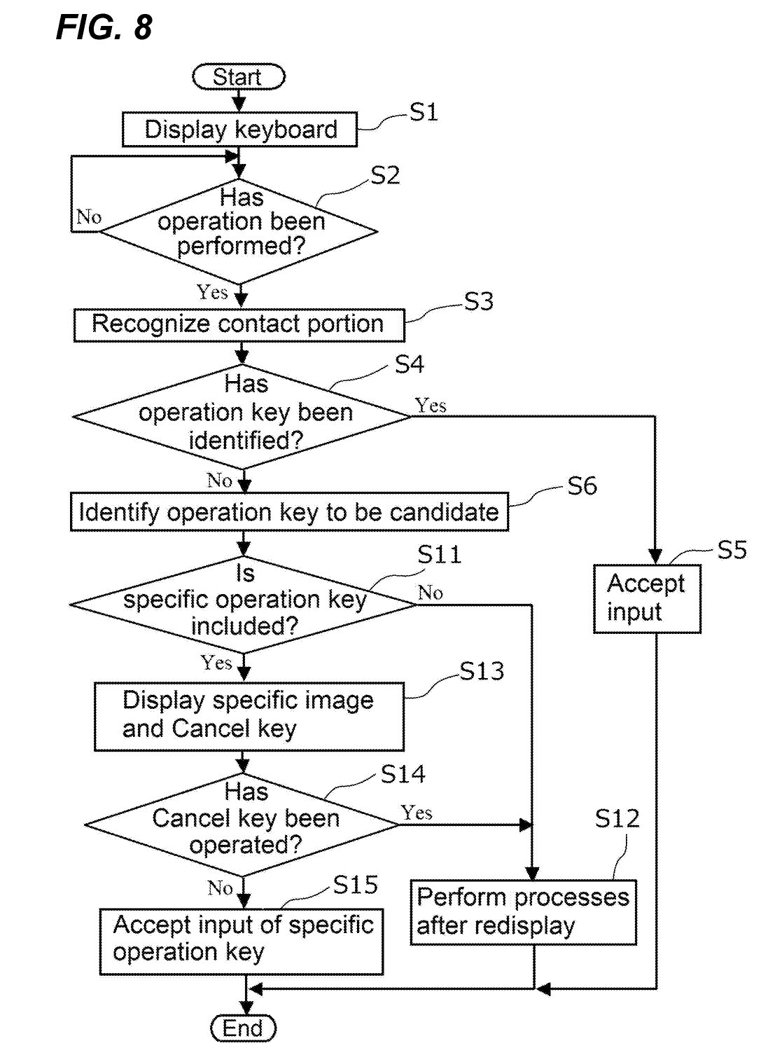

FIG. 8 illustrates one example of a flowchart corresponding to the above-described behaviors. Here, displaying the on-screen keyboard K (Step S1), recognizing presence/absence of the operation (Step S2), recognizing the contact portion (Step S3), recognizing the operation key in accordance with the contact portion (Step S4), accepting the input when the operation key is identified (Step S5), and identifying the operation key to be the candidate when the operation key is not identified (Step S6) are similar to the flowchart in FIG. 6. Here, the control unit 10 determines whether the specific operation key (an operation key having a function that displays a specific image such as the menu screen MN) like the “M” key is present or not (Step S11) among the operation keys as the candidate (Step S6). When the specific operation key is not included (No at step S11), the control unit 10 similarly performs the processes after the redisplay (Step S7) in the flowchart in FIG. 6 (Step S12). This causes the input acceptance to be performed by using the redisplay, similarly to the flowchart in FIG. 6.

When the specific operation key is included in the operation keys as the candidate (Yes at step S11), the control unit 10, as illustrated in FIG. 7B, deletes the on-screen keyboard K and displays the specific image such as the menu screen MN and the Cancel key C on the touch panel display 11 (Step S13). Subsequently, when it is recognized that the Cancel key C has been operated (Yes at Step S14), the control unit 10 deletes the specific image (the menu screen MN) and the Cancel key C and performs the processes after the redisplay (Step S7) in the flowchart in FIG. 6 (Step S12); thus, the acceptance of the input is performed by using the redisplay. Here, as described above, when the user releases his or her finger from the state of touching the Cancel key C, the operation of the Cancel key C is recognized.

When the Cancel key C is not operated (No at Step S14), the control unit 10 deletes the Cancel key C and performs the subsequent behaviors on the assumption that the input of the specific operation key (the “M” key) is performed (Step S15). Here, when the user releases his or her finger from the state of touching a region other than the Cancel key C, it is recognized that the Cancel key C is not operated.

In the above-described example, while the correspondence between the display of the menu screen MN as the specific image and the “M” key (the specific operation key) is established, the same can apply to the operation of displaying another specific image. When a plurality of specific operation keys are included among the operation keys as the candidate (Step S6), it is preferable to perform the behaviors in the flowchart in FIG. 6 instead of the behaviors in the flowchart in FIG. 8. Thus, it is possible to appropriately combine the behaviors in FIG. 6 with the behaviors in FIG. 8.

The above-described behaviors are especially preferable in a small-sized portable terminal that is likely to generate improper operations of the operation key. However, for a device where a touch panel display is used for inputting, it is apparent that the above-described behaviors are similarly effective. In this case, while the above-described example employs the operation keys (the on-screen keyboard K) constituted by a Roman character inputting method, any type can be employed; for example, it is possible to cause a numeric keypad or similar keypad to perform the above-described behaviors similarly. Alternatively, even in a case where a keyboard with an arrangement of the operation keys that have specific functions other than the input of characters and numerals is used, the above-described behaviors are effective when the respective operation keys are small and improper operations are likely to be generated.

### Exemplary Embodiment of the Disclosure

An input accepting device of the disclosure includes: a touch panel display that displays an on-screen keyboard with a plurality of operation keys arranged thereon; an input signal processing unit that recognizes a contact portion touched by a user in the touch panel display; and a control unit that recognizes an input corresponding to the operation key in accordance with a positional relationship between the recognized contact portion and the operation key in the on-screen keyboard. When the contact portion is recognized to correspond to the two or more operation keys, the control unit redisplays a new on-screen keyboard on the touch panel display in a state where the positional relationship of the respective operation keys in the arrangement on the on-screen keyboard is maintained. The new on-screen keyboard displays the two or more operation keys in a style different from the other operation keys. The control unit recognizes an operation with respect to the on-screen keyboard with the input signal processing unit.

In the input accepting device of the disclosure, when the contact portion is recognized to correspond to the two or more operation keys, the control unit highlights and redisplays the two or more operation keys, without changing positions of the respective operation keys in the on-screen keyboard displayed before the user touches.

In the input accepting device of the disclosure, the control unit sets priority levels of the respective two or more operation keys and redisplays after highlighting in accordance with the priority levels of the respective two or more operation keys.

In the input accepting device of the disclosure, the priority level is set in accordance with an area where each of the two or more operation keys overlaps with the contact portion.

In the input accepting device of the disclosure, the priority level is set in accordance with a distance between each of the two or more operation keys and the contact portion.

In the input accepting device of the disclosure, the priority level is set in accordance with a function corresponding to each of the two or more operation keys.

In the input accepting device of the disclosure, when the contact portion is recognized to correspond to the two or more operation keys, the control unit redisplays with a widen interval between the two or more operation keys in the on-screen keyboard displayed before the user touches.

In the input accepting device of the disclosure, when the contact portion is recognized to correspond to the two or more operation keys, the control unit redisplays while reducing the operation keys in size other than the two or more operation keys in the on-screen keyboard displayed before the user touches.

In the input accepting device of the disclosure, when the contact portion is recognized to correspond to the two or more operation keys, the control unit redisplays the operation keys such that the operation keys redisplayed with the widen interval are separated from the contact portion.

In the input accepting device of the disclosure, the input signal processing unit recognizes the contact portion when the user touches the touch panel display. When a state where the user touches the touch panel display is shifted to a state where the user does not touch, the control unit recognizes an input corresponding to the operation key recognized most recently touched by the user.

An input accepting device of the disclosure includes: a touch panel display that displays an on-screen keyboard with a plurality of operation keys arranged thereon; an input signal processing unit that recognizes a contact portion touched by a user in the touch panel display; and a control unit that recognizes an input corresponding to the operation key in accordance with a positional relationship between the recognized contact portion and the operation key in the on-screen keyboard. When the control unit recognizes that the contact portion corresponds to two or more operation keys, and one of the two or more operation keys corresponds to a function that displays a specific image in the touch panel display, the control unit displays a Cancel key on the touch panel display. The Cancel key is an operation key for aborting the display of the specific image and performs an operation to display the on-screen keyboard again, together with the specific image.

In the input accepting device of the disclosure, the control unit displays the Cancel key at a position near the contact portion and separated from the contact portion in the touch panel display.

### Effect of the Disclosure

The above-described configuration ensures reduced fatigue of a user as well as reduced improper operation in using a small-sized on-screen keyboard.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An input accepting device comprising:
a touch panel display that displays an on-screen keyboard with a plurality of operation keys arranged thereon;
an input signal processing unit that recognizes a contact portion touched by a user in the touch panel display; and
a control unit that recognizes an input corresponding to the operation key in accordance with a positional relationship between the recognized contact portion and the operation key in the on-screen keyboard,
wherein when the contact portion is recognized to correspond to the two or more operation keys, the control unit redisplays a new on-screen keyboard on the touch panel display in a state where the positional relationship of the respective operation keys in the arrangement on the on-screen keyboard is maintained, the new on-screen keyboard displaying the two or more operation keys in a style different from the other operation keys, and the control unit recognizes an operation with respect to the on-screen keyboard with the input signal processing unit.

2. The input accepting device according to claim 1,
wherein when the contact portion is recognized to correspond to the two or more operation keys, the control unit highlights and redisplays the two or more operation keys, without changing positions of the respective operation keys in the on-screen keyboard displayed before the user touches.

3. The input accepting device according to claim 2,
wherein the control unit sets priority levels of the respective two or more operation keys and redisplays the respective two or more operation keys highlighted in accordance with the priority levels of the respective two or more operation keys.

4. The input accepting device according to claim 3,
wherein the priority level is set in accordance with an area where each of the two or more operation keys overlaps with the contact portion.

5. The input accepting device according to claim 3,
wherein the priority level is set in accordance with a distance between each of the two or more operation keys and the contact portion.

6. The input accepting device according to claim 3,
wherein the priority level is set in accordance with a function corresponding to each of the two or more operation keys.

7. The input accepting device according to claim 1,
wherein when the contact portion is recognized to correspond to the two or more operation keys, the control unit redisplays the two or more operation keys with a widen interval between the two or more operation keys in the on-screen keyboard displayed before the user touches.

8. The input accepting device according to claim 7,
wherein when the contact portion is recognized to correspond to the two or more operation keys, the control unit redisplays the operation keys other than the two or more operation keys while reducing the operation keys in size other than the two or more operation keys in the on-screen keyboard displayed before the user touches.

9. The input accepting device according to claim 7,
wherein when the contact portion is recognized to correspond to the two or more operation keys, the control unit redisplays the operation keys such that the operation keys redisplayed with the widen interval are separated from the contact portion.

10. The input accepting device according to claim 2,
wherein the input signal processing unit recognizes the contact portion when the user touches the touch panel display, and
when a state where the user touches the touch panel display is shifted to a state where the user does not touch the touch panel display, the control unit recognizes an input corresponding to the operation key recognized most recently touched by the user.

11. An input accepting device comprising:
a touch panel display that displays an on-screen keyboard with a plurality of operation keys arranged thereon;
an input signal processing unit that recognizes a contact portion touched by a user in the touch panel display; and
a control unit that recognizes an input corresponding to the operation key in accordance with a positional relationship between the recognized contact portion and the operation key in the on-screen keyboard,
wherein when the control unit recognizes that the contact portion corresponds to two or more operation keys, and one of the two or more operation keys corresponds to a function that displays a specific image in the touch panel display, the control unit displays a Cancel key on the touch panel display, the Cancel key being an operation key for aborting the display of the specific image and performs an operation to display the on-screen keyboard again, together with the specific image.

12. The input accepting device according to claim 11,
wherein the control unit displays the Cancel key at a position near the contact portion and separated from the contact portion in the touch panel display.
